(19) United States
(12) Patent Application Publication
(10) Pub. No.: US 2022/0126124 A1
(43) Pub. Date: Apr. 28, 2022

(54) METHOD AND SYSTEM FOR AUTOMATIC NAILING OF HEAD MOUNTED MASK

(71) Applicant: Health Pro Supplies Limited, Kowloon (HK)

(72) Inventor: Shum Hin LUNG, Kowloon (HK)

(21) Appl. No.: 17/078,860

(22) Filed: Oct. 23, 2020

(51) Int. Cl. A62B 9/04; B27F 7/02; A62B 18/08

(52) U.S. Cl. CPC A62B 9/04; A62B 18/084; B27F 7/02

(57) ABSTRACT

Disclosed are a method and system for automatic nailing of head-mounted mask. The method is applied to a head-mounted mask processing system including an upright template, a feeding cylinder, a limit device and a nailing cylinder, and includes: fixing the head-mounted mask to the upright template with movable bottom plate, and moving the upright template to a nailing position; controlling cutting lengths of a neck strap and head strap by using the limit device, and transporting the neck strap and head strap to the nailing position through the feeding cylinder for cutting; and fixing the cut neck strap and head strap to left and right sides of the head-mounted mask on the upright template by using the nailing cylinder based on three-axis motion at the nailing position. The method and system can improve the efficiency of producing the head-mounted mask, save labor costs, and greatly improve the quality of products.

### FIELD OF THE INVENTION

The present invention relates to the field of mask production technology, in particular to a method and system for automatic nailing of a head-mounted mask.

### BACKGROUND OF THE INVENTION

Masks are a kind of health protection products, usually worn on the mouth and nose to filter air entering the mouth and nose, and to block droplets, dust, pollen, etc. in the air. The mask is usually hung on human ears by means of ear straps, so that the mask body can fit on the mouth and nose. Therefore, in the production process of a mask, one of the steps is to bend the ear straps into semicircles, and then weld two ends of the ear straps to the mask body.

However, the step of nailing on the mask is done manually, causing low production efficiency, high work intensity, mechanical repetition, and low processing efficiency of the entire mask.

### SUMMARY OF THE INVENTION

The technical problem to be solved by the present invention is to provide a method and system for automatic nailing of a head-mounted mask, which can automatically realize the process of nailing the mask, greatly increase the output and reduce the labor cost.

In order to solve the above technical problem, the first aspect of the present invention discloses a method for automatic nailing of a head-mounted mask, the method is applied to a head-mounted mask processing system, the head-mounted mask processing system includes an upright template, a feeding cylinder, a limit device and a nailing cylinder, and the method includes: fixing the head-mounted mask to the upright template with a movable bottom plate, and moving the upright template to a nailing position; controlling cutting lengths of a neck strap and a head strap by using the limit device, and transporting the neck strap and the head strap to the nailing position through the feeding cylinder for cutting; and fixing the cut neck strap and head strap to left and right sides of the head-mounted mask on the upright template by using the nailing cylinder based on three-axis motion at the nailing position.

In some implementation modes, controlling cutting lengths of a neck strap and a head strap by using the limit device includes: configuring and storing the cutting lengths of the neck strap and the head strap as a cutting length rule; and changing the position of the limit device according to the cutting length rule to determine the cutting lengths of the neck strap and the head strap.

In some implementation modes, transporting the neck strap and the head strap to the nailing position through the feeding cylinder for cutting includes: adjusting air pressure according to the cutting lengths of the neck strap and the head strap through the feeding cylinder, and controlling the feeding tension according to the air pressure to meet the deformation requirements of the neck strap and the head strap.

In some implementation modes, fixing the cut neck strap and head strap to left and right sides of the head-mounted mask on the upright template by using the nailing cylinder based on three-axis motion at the nailing position includes: when the upright template fixed with the head-mounted mask and the cut neck strap and head strap are moved to the same nailing position, pressing metal nails, the neck strap and the head strap to the left and right sides of the head-mounted mask by using the nailing cylinder.

In some implementation modes, the cutting lengths of the neck strap and the head strap are both 0.6 mm thick and 5 mm wide.

According to the second aspect of the present invention, a system for automatic nailing of a head-mounted mask is disclosed, including: a fixing module for fixing the head-mounted mask to an upright template with a movable bottom plate, and moving the upright template to a nailing position; a cutting module for controlling cutting lengths of a neck strap and a head strap by using a limit device, and transporting the neck strap and the head strap to the nailing position through a feeding cylinder for cutting; and a nailing module for fixing the cut neck strap and head strap to left and right sides of the head-mounted mask on the upright template by using a nailing cylinder based on three-axis motion at the nailing position.

In some implementation modes, the cutting module includes: a limit unit for changing the position of the limit device according to the configured cutting length rule including the cutting lengths of the neck strap and the head strap to determine the cutting lengths of the neck strap and the head strap.

In some implementation modes, the cutting module further includes: a feeding unit for adjusting air pressure according to the cutting lengths of the neck strap and the head strap through the feeding cylinder, and controlling the feeding tension according to the air pressure to meet the deformation requirements of the neck strap and the head strap.

In some implementation modes, the nailing module is configured for: when the upright template fixed with the head-mounted mask and the cut neck strap and head strap are moved to the same nailing position, pressing metal nails, the neck strap and the head strap to the left and right sides of the head-mounted mask by using the nailing cylinder.

According to the third aspect of the present invention, an apparatus for automatic nailing of a head-mounted mask is disclosed, including: a memory storing executable program codes; and a processor connected to the memory; wherein the processor calls the executable program codes stored in the memory to execute the method for automatic nailing of the head-mounted mask described above.

Compared with the prior art, the beneficial effects of the present invention are:

The implementation of the present invention can greatly increase the output, overcome the problem of slow manual processing in the prior art, and reduce the manufacturing costs of products by reducing manual procedures of the process. In addition, through the automatic control on the cutting lengths of the neck strap and head strap and the transmission tension, the fixed lengths and positions are maintained at the standard of quality requirements, which greatly improves the quality of products and reduces scrap products.

### BRIEF DESCRIPTION OF THE DRAWINGS

FIG. 1 is a schematic flowchart of a method for automatic nailing of a head-mounted mask according to an embodiment of the present invention;

FIG. 2 is a block diagram of a system for automatic nailing of a head-mounted mask according to an embodiment of the present invention; and

FIG. 3 is a schematic structural diagram of an interactive apparatus for automatic nailing of ahead-mounted mask according to an embodiment of the present invention.

### DETAILED DESCRIPTION OF THE EMBODIMENTS

For better understanding and implementation, the technical solutions in the embodiments of the present invention will be clearly and completely described below with reference to the accompanying drawings in the embodiments of the present invention. Apparently, the described embodiments are some of, not all of the embodiments of the present invention. All other embodiments obtained by those of ordinary skill in the art based on the embodiments of the present invention without any creative effort shall fall within the scope of protection of the present invention.

The terms “include” and “have” and any variations thereof in the embodiments of the present invention are intended to cover a non-exclusive inclusion, for example, a process, method, system, product or device including a series of steps or modules is not necessarily limited to those steps or modules listed, but may include other steps or modules not explicitly listed or inherent to such a process, method, system, product or device.

The embodiments of the present invention disclose a method and system for automatic nailing of a head-mounted mask, which can greatly increase the output, overcome the problem of slow manual processing in the prior art, and reduce the manufacturing costs of products by reducing manual procedures of the process. In addition, through the automatic control on the cutting lengths of a neck strap and a head strap and the transmission tension, the fixed lengths and positions are maintained at the standard of quality requirements, which greatly improves the quality of products and reduces scrap products.

### Embodiment 1

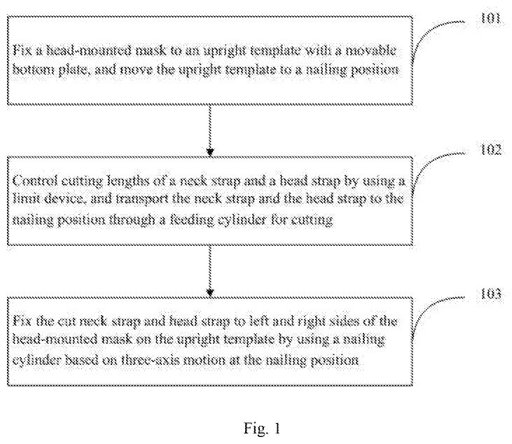

Please refer to FIG. 1. FIG. 1 is a schematic flowchart of a method for automatic nailing of a head-mounted mask according to an embodiment of the present invention. The method for automatic nailing of the head-mounted mask can be applied to a head-mounted mask processing system. The head-mounted mask processing system includes an upright template, a feeding cylinder, a limit device and a nailing cylinder. The functions or application scenarios of other head-mounted mask processing systems are not limited in the embodiments of the present invention. As shown in FIG. 1, the method for automatic nailing of the head-mounted mask includes:

Step 101, the head-mounted mask is fixed to the upright template with a movable bottom plate, and the upright template is moved to a nailing position.

In the existing head-mounted masks, especially N95 (KN95) head-mounted masks, the head strap and neck strap are fixed with metal nails in a manner similar to staples, and the requirements for the lengths and positions of the head strap and neck strap are different from those for conventional masks. At present, the head straps and neck straps of the products on the market are mostly cut and nailed to the left and right sides of the masks manually, causing the problems of low output, low labor productivity, high product cost, etc.

In order to realize automatic nailing of the head strap and neck strap, the head-mounted mask to be nailed is first fixed, which is specifically implemented as the head-mounted mask is sleeved on the upright template in the same shape as the head-mounted mask. In order to improve the stability of the fixation, the head-mounted mask is further fixed with clips to avoid movement. Moreover, in order to meet the automation of the process, the upright template is further equipped with the movable bottom plate, and the head-mounted mask is transported to the nailing position by controlling the movable bottom plate, wherein the control can be preprogrammed based on a PLC control circuit.

Step 102, cutting lengths of a neck strap and a head strap are controlled by using the limit device, and the neck strap and the head strap are transported to the nailing position through the feeding cylinder for cutting.

Since the material used for the head strap and neck strap is TPU (thermoplastic polyurethane elastomer), non-latex materials may also be used in other embodiments. Therefore, the neck strap and the head strap are easily elongated during cutting or transport, and the control on their tension is particularly important. The cutting lengths of the neck strap and the head strap are controlled by using the limit device as follows: first, the cutting lengths of the neck strap and the head strap are configured and stored as a cutting length rule. In this embodiment, the cutting lengths of the neck strap and the head strap are both 0.6 mm thick and 5 mm wide. When applied to masks of other specifications, the cutting lengths of the neck strap and the head strap can be changed. Then, the position of the limit device, i.e., the cutting position that limits the cutting length, is changed according to the cutting length rule, thereby determining the cutting lengths of the neck strap and the head strap.

Further, the cut neck strap and head strap are transported to the nailing position through the feeding cylinder for cutting, which is specifically implemented as: air pressure is adjusted through the feeding cylinder according to the cutting lengths of the neck strap and the head strap, and the feeding tension is controlled according to the air pressure to meet the deformation requirements of the neck strap and head strap, thereby ensuring that the feeding tension is stable during the entire process of transporting the neck strap and the head strap, and the neck strap and the head strap will not be deformed by unnecessary pulling.

It should be noted that the present invention does not limit the order of execution of step 101 and step 102. In order to save the time of the production process, the two steps can also be executed at the same time. The aforementioned orders of execution fall into the protection scope of the present invention.

Step 103, the cut neck strap and head strap are fixed to left and right sides of the head-mounted mask on the upright template by using the nailing cylinder based on three-axis motion at the nailing position.

When the upright template fixed with the head-mounted mask and the cut neck strap and head strap are moved to the same nailing position, the control on the movement of the upright template fixed with the head-mounted mask and the cut neck strap and head strap to the same nailing position is implemented by the PLC control circuit. After that, the metal nails, neck strap and head strap are pressed to the left and right sides of the head-mounted mask by using the nailing cylinder, which can be specifically implemented as: after the head-mounted mask, the head strap, and the neck strap are all at the nailing position, nail heads are driven by the pushing of the cylinder to cut and fold metal strips nailed to the head-mounted mask, and then the nail heads are pressed with the neck strap and the head strap, thereby completing the process of automatically nailing the neck strap and head strap to the head-mounted mask.

In the actual operation of the present invention, the inventors found that the nailing output of head-mounted masks using this automated method has doubled, from 30 seconds/piece for manual processing to 15 seconds/piece for automatic processing. By reducing this procedure, the labor cost is saved. Moreover, the fixed position error of automatically nailing the neck strap and head strap by means of PLC control is 0.3 to 0.5 mm. Compared with the manual processing error of 1 to 2 mm, the quality of products is greatly improved and the output of scrap products is reduced.

### Embodiment 2

Please refer to FIG. 2. FIG. 2 is a block diagram of a system for automatic nailing of a head-mounted mask according to an embodiment of the present invention. The system for automatic nailing of the head-mounted mask can be implemented as a head-mounted mask processing system. As shown in FIG. 2, the system for automatic nailing of the head-mounted mask includes:

A fixing module 1 for fixing the head-mounted mask to an upright template with a movable bottom plate, and moving the upright template to a nailing position.

In order to realize automatic nailing of a head strap and a neck strap, the head-mounted mask to be nailed is first fixed, which is specifically implemented as the head-mounted mask is sleeved on the upright template in the same shape as the head-mounted mask. In order to improve the stability of the fixation, the head-mounted mask is further fixed with clips to avoid movement. Moreover, in order to meet the automation of the process, the upright template is further equipped with the movable bottom plate, and the head-mounted mask is transported to the nailing position by controlling the movable bottom plate, wherein the control can be preprogrammed based on a PLC control circuit.

A cutting module 2 for controlling cutting lengths of the neck strap and the head strap by using a limit device, and transporting the neck strap and the head strap to the nailing position through a feeding cylinder for cutting.

A nailing module 3 for fixing the cut neck strap and head strap to left and right sides of the head-mounted mask on the upright template by using a nailing cylinder based on three-axis motion at the nailing position.

The cutting module 2 includes: a limit unit 201 for changing the position of the limit device according to the configured cutting length rule including the cutting lengths of the neck strap and the head strap to determine the cutting lengths of the neck strap and the head strap.

The cutting module 2 further includes: a feeding unit 202 for adjusting air pressure according to the cutting lengths of the neck strap and the head strap through the feeding cylinder, and controlling the feeding tension according to the air pressure to meet the deformation requirements of the neck strap and the head strap.

Since the material used for the head strap and neck strap is TPU (thermoplastic polyurethane elastomer), non-latex materials may also be used in other embodiments. Therefore, the neck strap and the head strap are easily elongated during cutting or transport, and the control on their tension is particularly important. The cutting lengths of the neck strap and the head strap are controlled by using the limit device as follows: first, the cutting lengths of the neck strap and the head strap are configured and stored as a cutting length rule. In this embodiment, the cutting lengths of the neck strap and the head strap are both 0.6 mm thick and 5 mm wide. When applied to masks of other specifications, the cutting lengths of the neck strap and the head strap can be changed. Then, the position of the limit device, i.e., the cutting position that limits the cutting length, is changed according to the cutting length rule, thereby determining the cutting lengths of the neck strap and the head strap.

Further, the cut neck strap and head strap are transported to the nailing position through the feeding cylinder for cutting, which is specifically implemented as: air pressure is adjusted through the feeding cylinder according to the cutting lengths of the neck strap and the head strap, and the feeding tension is controlled according to the air pressure to meet the deformation requirements of the neck strap and head strap, thereby ensuring that the feeding tension is constant during the entire process of transporting the neck strap and the head strap, and the neck strap and the head strap will not be deformed by unnecessary pulling.

It should be noted that the present invention does not limit the order of execution of the limit unit 201 and the feeding unit 202. In order to save the time of the production process, the two modules can also execute at the same time. The aforementioned orders of execution fall into the protection scope of the present invention.

The nailing module 3 is configured for: when the upright template fixed with the head-mounted mask and the cut neck strap and head strap are moved to the same nailing position, pressing metal nails, the neck strap and the head strap to the left and right sides of the head-mounted mask by using the nailing cylinder.

When the upright template fixed with the head-mounted mask and the cut neck strap and head strap are moved to the same nailing position, the control on the movement of the upright template fixed with the head-mounted mask and the cut neck strap and head strap to the same nailing position is implemented by the PLC control circuit. After that, the metal nails, neck strap and head strap are pressed to the left and right sides of the head-mounted mask by using the nailing cylinder, which can be specifically implemented as: after the head-mounted mask, the head strap, and the neck strap are all at the nailing position, nail heads are driven by the pushing of the cylinder to cut and fold metal strips nailed to the head-mounted mask, and then the nail heads are pressed with the neck strap and the head strap, thereby completing the process of automatically nailing the neck strap and head strap to the head-mounted mask.

The system provided by this embodiment can greatly increase the output, overcome the problem of slow manual processing in the prior art, and reduce the manufacturing costs of products by reducing manual procedures of the process. In addition, through the automatic control on the cutting lengths of the neck strap and head strap and the transmission tension, the fixed lengths and positions are maintained at the standard of quality requirements, which greatly improves the quality of products and reduces scrap products.

### Embodiment 3

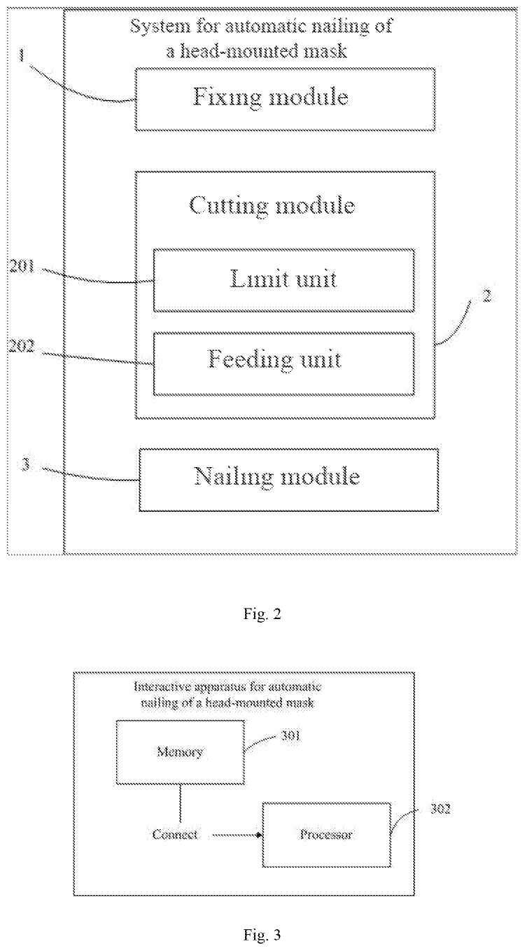

Please refer to FIG. 3. FIG. 3 is a schematic structural diagram of an apparatus for automatic nailing of a head-mounted mask according to an embodiment of the present invention. The apparatus described in FIG. 3 can be applied to a mask processing system, and the embodiment of the present invention does not limit the application system of the apparatus for automatic nailing of the head-mounted mask. As shown in FIG. 3, the apparatus may include:

a memory 301 storing executable program codes; and

a processor 302 connected to the memory 301;

wherein the processor 302 calls the executable program codes stored in the memory 301 to execute the method for automatic nailing of the head-mounted mask described in the first embodiment.

### Embodiment 4

The embodiment of the present invention discloses a computer-readable storage medium, storing computer programs for electronic data exchange, wherein the computer programs cause a computer to execute the method for automatic nailing of a head-mounted mask described in the first embodiment.

### Embodiment 5

The embodiment of the present invention discloses a computer program product.

The computer program product includes a non-transitory computer-readable storage medium storing computer programs, and the computer programs can be operated to cause a computer to execute the method for automatic nailing of the head-mounted mask described in the first embodiment.

The embodiments described above are merely schematic, wherein the modules illustrated as separate components may be or may not be physically separated, and the components displayed as modules may be or may not be physical modules, that is, the components may be located at one place or distributed on a plurality of network modules. The objectives of the solutions of the embodiments may be fulfilled by selecting part of or all of the modules according to actual needs. Those of ordinary skill in the art can understand and implement without any creative effort.

Through the specific descriptions of the above embodiments, those skilled in the art can clearly understand that the various implementation modes can be implemented by means of software and a necessary universal hardware platform. Of course, the implementation modes can also be implemented by hardware. Based on this understanding, the above technical solution essentially or the part that contributes to the prior art can be embodied in the form of a software product. The computer software product can be stored in a computer-readable storage medium, including a Read-Only Memory (ROM), a Random Access Memory (RAM), a Programmable Read-only Memory (PROM), an Erasable Programmable Read Only Memory (EPROM), a One-time Programmable Read-Only Memory (OTPROM), an Electronically-Erasable Programmable Read-Only Memory (EEPROM), a Compact Disc Read-Only Memory (CD-ROM) or other CD memory, disk memory, tape memory, or any other computer-readable medium that can be used to carry or store data.

Finally, it should be noted that the embodiments disclosed by the method and system for automatic nailing of the head-mounted mask according to the embodiments of the present invention are merely preferred embodiments of the present invention, and are merely for explaining, but not limiting, the technical solutions of the present invention; although the present invention is described in detail with reference to the foregoing embodiments, those of ordinary skill in the art should understood that the technical solutions described in the foregoing embodiments may still be modified, or some of the technical features may be equivalently substituted; and such modifications or substitutions do not make the essence of the corresponding technical solutions depart from the spirit and scope of the technical solutions of various embodiments of the present invention.

1. A method for automatic nailing of a head-mounted mask, wherein the method is applied to a head-mounted mask processing system, the head-mounted mask processing system comprises an upright template, a feeding cylinder, a limit device and a nailing cylinder, and the method comprises:
fixing the head-mounted mask to the upright template with a movable bottom plate, and moving the upright template to a nailing position;
controlling cutting lengths of a neck strap and a head strap by using the limit device, and transporting the neck strap and the head strap to the nailing position through the feeding cylinder for cutting; and
fixing the cut neck strap and head strap to left and right sides of the head-mounted mask on the upright template by using the nailing cylinder based on three-axis motion at the nailing position.

2. The method for automatic nailing of the head-mounted mask according to claim 1, wherein controlling cutting lengths of a neck strap and a head strap by using the limit device comprises:
configuring and storing the cutting lengths of the neck strap and the head strap as a cutting length rule; and
changing the position of the limit device according to the cutting length rule to determine the cutting lengths of the neck strap and the head strap.

3. The method for automatic nailing of the head-mounted mask according to claim 2, wherein transporting the neck strap and the head strap to the nailing position through the feeding cylinder for cutting comprises:
adjusting air pressure according to the cutting lengths of the neck strap and the head strap through the feeding cylinder, and controlling the feeding tension according to the air pressure to meet the deformation requirements of the neck strap and the head strap.

4. The method for automatic nailing of the head-mounted mask according to claim 3, wherein fixing the cut neck strap and head strap to left and right sides of the head-mounted mask on the upright template by using the nailing cylinder based on three-axis motion at the nailing position comprises:
when the upright template fixed with the head-mounted mask and the cut neck strap and head strap are moved to the same nailing position, pressing metal nails, the neck strap and the head strap to the left and right sides of the head-mounted mask by using the nailing cylinder.

5. The method for automatic nailing of the head-mounted mask according to claim 1, wherein the cutting lengths of the neck strap and the head strap are both 0.6 mm thick and 5 mm wide.

6. A system for automatic nailing of a head-mounted mask, comprising:
a fixing module for fixing the head-mounted mask to an upright template with a movable bottom plate, and moving the upright template to a nailing position;
a cutting module for controlling cutting lengths of a neck strap and a head strap by using a limit device, and transporting the neck strap and the head strap to the nailing position through a feeding cylinder for cutting; and
a nailing module for fixing the cut neck strap and head strap to left and right sides of the head-mounted mask on the upright template by using a nailing cylinder based on three-axis motion at the nailing position.

7. The system for automatic nailing of the head-mounted mask according to claim 6, wherein the cutting module comprises:
a limit unit for changing the position of the limit device according to the configured cutting length rule comprising the cutting lengths of the neck strap and the head strap to determine the cutting lengths of the neck strap and the head strap.

8. The system for automatic nailing of the head-mounted mask according to claim 6, wherein the cutting module further comprises:
a feeding unit for adjusting air pressure according to the cutting lengths of the neck strap and the head strap through the feeding cylinder, and controlling the feeding tension according to the air pressure to meet the deformation requirements of the neck strap and the head strap.

9. The system for automatic nailing of the head-mounted mask according to claim 8, wherein the nailing module is configured for:
when the upright template fixed with the head-mounted mask and the cut neck strap and head strap are moved to the same nailing position, pressing metal nails, the neck strap and the head strap to the left and right sides of the head-mounted mask by using the nailing cylinder.

10. An apparatus for automatic nailing of a head-mounted mask, comprising:
a memory storing executable program codes; and
a processor connected to the memory;
wherein the processor calls the executable program codes stored in the memory to execute the method for automatic nailing of the head-mounted mask according to claim 1.
